(19) United States
(12) Patent Application Publication
(10) Pub. No.: US 2024/0208126 A1
(43) Pub. Date: Jun. 27, 2024

(54) MANAGEMENT APPARATUS, MANAGEMENT METHOD, AND STORAGE MEDIUM

(71) Applicant: KABUSHIKI KAISHA TOSHIBA, Tokyo (JP)

(72) Inventors: Shinya HIGASHI, Yokohama (JP); Hiroaki NAKAMURA, Kawasaki (JP); Satoshi SAYAMA, Yokohama (JP); Kiminori TOYA, Yokohama (JP); Ryo TAKAMI, Yokohama (JP)

(73) Assignee: KABUSHIKI KAISHA TOSHIBA, Tokyo (JP)

(21) Appl. No.: 18/485,421

(22) Filed: Oct. 12, 2023

(30) Foreign Application Priority Data
Dec. 21, 2022 (JP) 2022-204503

(51) Int. Cl. B29C 45/76

(52) U.S. Cl. CPC B29C 45/766; B29C 2945/76949

(57) ABSTRACT

According to one embodiment, a management apparatus includes a processor comprising hardware. The processor calculates, based on information on two or more parameters for production of a part and an evaluation value for a quality of the part produced, a prediction formula representing a relationship between the quality and the parameters. The processor calculates, based on the prediction formula, an optimum value for the parameters. The processor causes a display to display a graph indicative of a relationship between the prediction formula and the optimum value.

### CROSS-REFERENCE TO RELATED APPLICATION(S)

This application is based upon and claims the benefit of priority from Japanese Patent Application No. 2022-204503, filed Dec. 21, 2022, the entire contents of which are incorporated herein by reference.

### FIELD

Embodiments described herein relate generally to a management apparatus, a management method, and a storage medium.

### BACKGROUND

A manufacturing apparatus such as an injection molding machine produces parts using many parameters as inputs. Conventionally, determining values of such many parameters relied on the know-how of skilled persons. Thus, it cannot be said that input parameters were undoubtedly optimal. A technique is available which calculates optimum conditions on the assumption that there is already knowledge about how an evaluation value indicating quality of produced parts relates to input parameters. However, it is not always the case that a relationship between an evaluation value indicating quality of a produced part and input parameters is known. Even if the relationship between an evaluation value indicating quality of a produced part and an input parameter is known, a multi-dimensional parameter space, which involves many mutually influencing parameters, renders the search sparse so that detailed relationships are unclear and the search may not be able to acquire optimum conditions. Also, in instances where the relationship between an evaluation value indicating quality of a produced part and input parameters is not known, it is difficult for the user of the manufacturing apparatus to determine whether or not a result of the optimum condition calculation, even if successfully finished, would actually be the optimum condition.

### BRIEF DESCRIPTION OF THE DRAWINGS

FIG. 1 is a diagram showing an exemplary configuration of a manufacturing system including a management apparatus according to an embodiment.

FIG. 2 is a block diagram showing one example of a hardware configuration of an exemplary management apparatus.

FIG. 3 is a diagram showing an exemplary graph representation corresponding to a prediction formula.

FIG. 4 is a flowchart for explaining operations of the management apparatus.

FIG. 5 is a diagram showing one example of a top screen.

FIG. 6 is a diagram showing a graph of a response surface representing a relationship of a deformation amount with an injection velocity and a cool-down time.

FIG. 7A is a diagram showing a graph of a response curve representing a relationship of a deformation amount with dwelling.

FIG. 7B is a diagram showing a graph of the response curve representing a relationship of a deformation amount with dwelling and updated according to an input of a candidate value.

FIG. 7C is a diagram showing a graph updated by recalculation of a prediction formula using a candidate value for dwelling input during the display of the graph shown in FIG. 7A.

FIG. 8 is a flowchart for explaining a process for prediction formula calculation according to a first modification.

FIG. 9A is a diagram showing sensitivity and a confidence interval of a response curve.

FIG. 9B is a diagram showing sensitivity and a confidence interval of a response curve.

FIG. 10 is a flowchart for explaining a process for prediction formula calculation according to a second modification.

FIG. 11 is a flowchart for explaining a process for prediction formula calculation according to a third modification.

### DETAILED DESCRIPTION

In general, according to one embodiment, a management apparatus includes a processor comprising hardware. The processor calculates, based on information on two or more parameters for production of a part and an evaluation value for a quality of the part produced, a prediction formula representing a relationship between the quality and the parameters. The processor calculates, based on the prediction formula, an optimum value for the parameters. The processor causes a display to display a graph indicative of a relationship between the prediction formula and the optimum value.

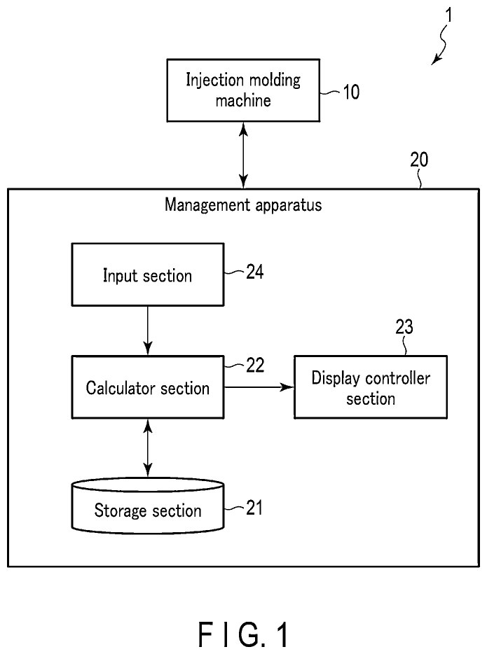

Embodiments will be described with reference to the drawings. FIG. 1 is a diagram showing an exemplary configuration of a manufacturing system including a management apparatus according to an embodiment. As shown in FIG. 1, this manufacturing system 1 includes an injection molding machine 10 which is one example of a manufacturing apparatus, and a management apparatus 20 serving as a managing entity for managing the manufacturing apparatus or apparatuses.

The injection molding machine 10 produces parts by carrying out injection molding based on parameters set by the management apparatus 20. The injection molding machine 10 may employ a desired configuration.

The management apparatus 20 may be a computer for managing the injection molding machine 10. The management apparatus 20 calculates a prediction formula representing a relationship between an evaluation value or values indicating a quality of a part to be produced by the injection molding machine 10 and a parameter or parameters, and calculates, based on this prediction formula, an optimum value of each parameter that will optimize the quality of the part to be produced. The management apparatus 20 presents the thus calculated parameter together with the prediction formula to the user, etc. of the management apparatus 20.

The management apparatus 20 includes a storage section 21, a calculator section 22, a display controller section 23, and an input section 24.

The storage section 21 stores information on quality-indicating evaluation values and parameters. One example of such information on evaluation values and parameters is information containing values of respective parameters of a parameter group set for the injection molding machine 10 in the past, and an evaluation value or values for each part produced using this parameter group. A parameter group for the injection molding machine 10 may include at least one of a resin temperature, a measurement point, a back pressure, an injection velocity, a V/P switchover point, dwelling (pressure keeping), a dwelling time, a cool-down time, a mold temperature, and/or the like. Also, evaluation values for the injection molding machine 10 may include at least one of a measurement (a sink mark amount, a warp amount, a flash, and/or a short mold), a mass, a weld line, and/or the like.

The calculator section 22 calculates, based on the information on evaluation values and parameters stored in the storage section 21, a prediction formula representing a relationship between a parameter group set for the injection molding machine 10 and an evaluation value or values indicating quality of a part to be produced using the parameter group, and calculates, based on this prediction formula, an optimum value of each parameter that will optimize the quality of the to-be-produced part. An optimum value search for multiple variables is performed by, for example, Bayesian optimization. To employ Bayesian optimization, a prediction formula calculation is performed by a Gaussian process regression, which is one regression analysis technique. Note that the prediction formula calculation may also be performed by a method other than the Gaussian process regression. Optimum value search for multiple variables based on the prediction formula may also be performed by various optimum value search techniques other than the Bayesian optimization.

The display controller section 23 controls various display operations with a given display. In one example, the display controller section 23 controls a display to display a prediction formula in the form of a graph together with an optimum value on the prediction formula, so that a user of the management apparatus 20 can confirm.

The input section 24 accepts various inputs from a user, etc. These inputs include an input of a candidate value for a parameter, and so on.

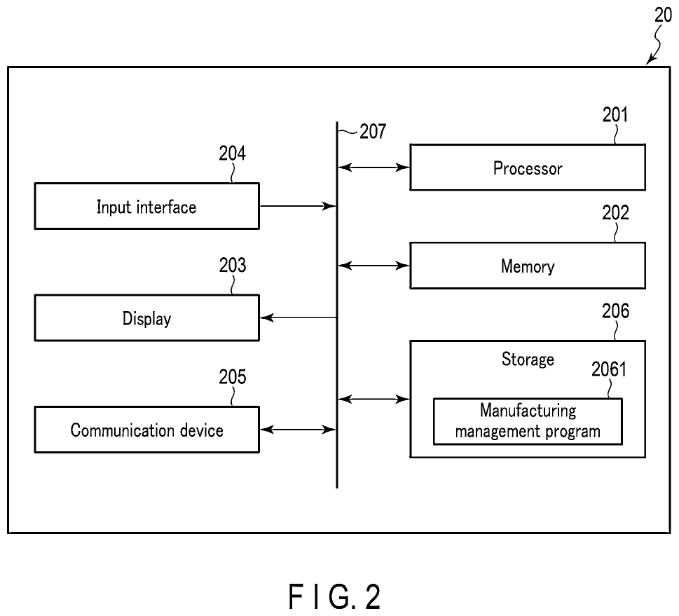

FIG. 2 is a block diagram showing one example of a hardware configuration of the management apparatus 20. The management apparatus 20 includes a processor 201, a memory 202, a display 203, an input interface 204, a communication device 205, and a storage 206. The processor 201, the memory 202, the display 203, the input interface 204, the communication device 205, and the storage 206 are connected to a bus 207.

The processor 201 takes total control over the operations of the management apparatus 20. In one example, the processor 201 executes a manufacturing management program 2061 stored in the storage 206 to operate as the calculator section 22, the display controller section 23, and the input section 24. The processor 201 may be, for example, a CPU. The processor 201 may be an MPU, a GPU, or the like. The processor 201 may be constituted by a single CPU or the like, or any combination of multiple elements including CPUs and the like.

The memory 202 is a storage device including a read only memory (ROM), a random access memory (RAM), etc. The ROM is a nonvolatile memory. The ROM stores a boot program, etc. for the management apparatus 20. The RAM is a volatile memory. In one example, the RAM is used as a working memory for the processor 201 to perform its processing.

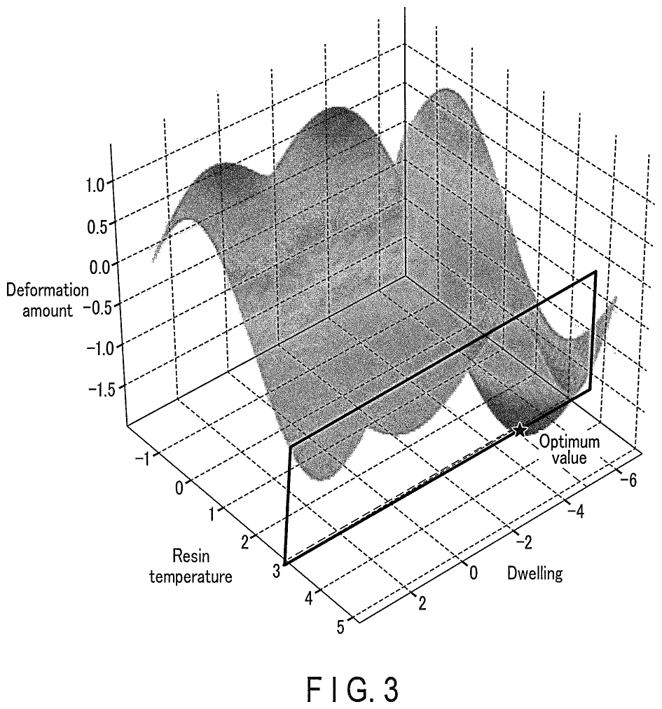

The display 203 includes one or more of a liquid crystal display, an organic EL display, and/or other displays. The display 203 may be provided as a discrete member from the management apparatus 20. The display 203 displays a graph corresponding to a prediction formula together with an optimum value. The graph corresponding to a prediction formula here is a one-variable graph or a two-variable graph. On the other hand, the prediction formula may involve multiple variables equal to or greater than three variables, and as such, the user of the management apparatus 20 selects one evaluation value and one or two parameters for graph representation. The processor 201 then prepares, from the prediction formula, a response curve or a response surface representing the relationship between the evaluation value and the parameter or parameters. The processor 201 controls the display 203 to display the prepared graph. FIG. 3 is a diagram showing an exemplary graph representation corresponding to a prediction formula. FIG. 3 illustrates the case of displaying a response surface, where two variables, i.e., dwelling and a resin temperature, are selected as the parameters and a deformation amount is selected as the evaluation value. The optimum value in this case is specified by the group of the dwelling and the resin temperature that gives the minimum evaluation value of the deformation amount on the response surface.

The input interface 204 includes one or more input devices such as a touch panel, a keyboard, and a mouse. Various inputs are made according to operations on the input devices. The input interface 204 may be provided as a discrete member from the management apparatus 20.

The communication device 205 is a device for enabling the management apparatus 20 to communicate with external entities such as the injection molding machine 10. The communication device 205 may be a device adapted for cable communication or a device adapted for wireless communication.

The storage 206 is a storage device which may be, for example, a hard disk drive, a solid state drive, etc. The storage 206 stores various programs for execution by the processor 201, such as the manufacture management program 2061. The storage 206 may also serve as the storage section 21 for storing past evaluation values and past values of parameter groups. Note that the past evaluation values and the past values of parameter groups may also be stored in, for example, one or more external storage media of the management apparatus 20, a cloud environment communicably provided for the management apparatus 20, and so on.

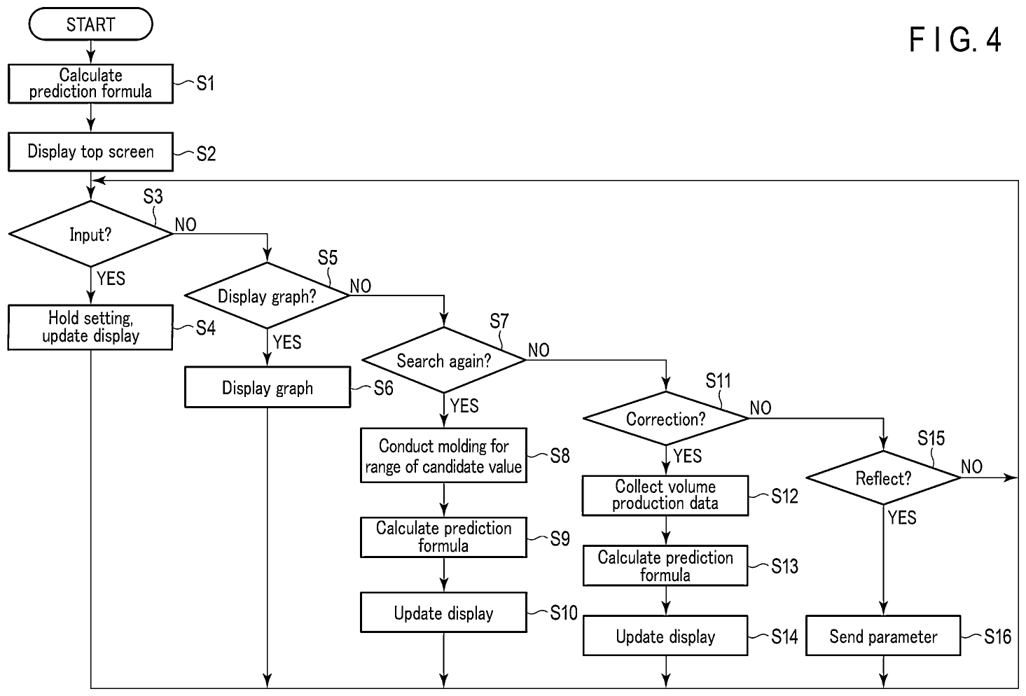

Next, how the management apparatus 20 operates will be described. FIG. 4 is a flowchart for explaining operations of the management apparatus 20. The processing steps shown in FIG. 4 are performed by the processor 201, for example, after activation of the management apparatus 20. Here, the description will assume an instance where it is determined in advance that a deformation amount is used as the evaluation value.

In step S1, the processor 201 calculates, based on past evaluation values and past values of parameter groups and through the Bayesian optimization or the like, a prediction formula representing a relationship between an evaluation value and a parameter group, and calculates, based on this prediction formula, an optimum value of each parameter that will optimize the quality of the part to be produced. Note that the prediction formula calculation in step S1 does not need to be performed every time the processing shown in FIG. 4 is started. The prediction formula calculation in step S1 may be performed at predetermined time intervals, e.g., weekly, monthly, or the like.

In step S2, the processor 201 causes the display 203 to display a top screen.

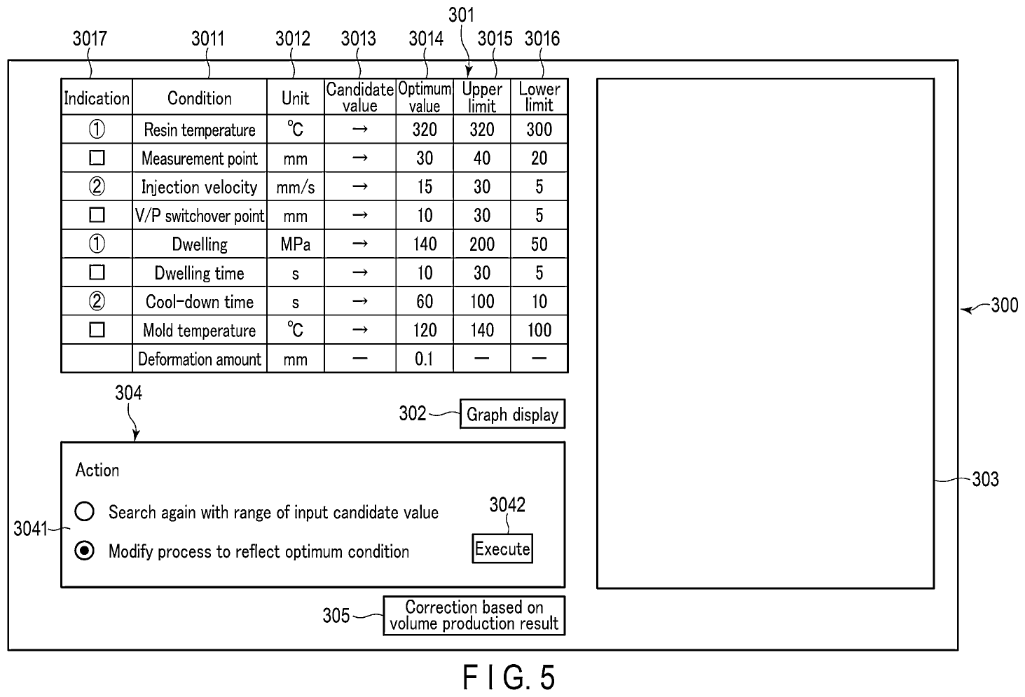

FIG. 5 is a diagram showing one example of the top screen. This exemplary top screen 300 includes a parameter display area 301, a graph display button 302, a graph display area 303, an action input area 304, and a correction button 305.

The parameter display area 301 is an area for displaying parameters set for the injection molding machine 10. In one example, the parameter display area 301 includes a condition name display area 3011, a unit display area 3012, a candidate value display area 3013, an optimum value display area 3014, an upper limit display area 3015, a lower limit display area 3016, and a selection display area 3017. The condition name display area 3011 is an area for displaying names of respective parameters. The unit display area 3012 is an area for displaying units of values of the respective parameters. The candidate value display area 3013 is an area for displaying candidate values for optimum values, input by a user, etc. of the management apparatus 20. As will be explained later, if a candidate value is input by a user, etc., the prediction formula calculation is carried out with the corresponding parameter fixed to a given range which covers the candidate value. The optimum value display area 3014 is an area for displaying optimum values of the respective parameters, obtained by the prediction formula calculated by the processor 201. The upper limit display area 3015 is an area for displaying upper limit values of parameters, determined by the user, etc. of the management apparatus 20. With an upper limit value determined, an optimum parameter value is calculated for the corresponding parameter within a range not exceeding the upper limit value. The lower limit display area 3016 is an area for displaying lower limit values of parameters, determined by the user, etc. of the management apparatus 20. With a lower limit value determined, an optimum parameter value is calculated for the corresponding parameter within a range equal to or exceeding the lower limit value. The selection display area 3017 is an area for displaying boxes for the user to select parameters. The same number is displayed for parameters that have been grouped into the same group. For example, FIG. 5 shows that each of a group of “Resin temperature” and “Dwelling” and a group of “Injection velocity” and “Cool-down time” has been selected.

The graph display button 302 is a button which is selected at the time of displaying a graph. Upon selection of the graph display button 302, a graph is created based on the prediction formula and the parameter group selected in the selection display area 3017.

The graph display area 303 is an area for displaying the created graph. If no parameter is selected in the selection display area 3017, no graph will be displayed in the graph display area 303. If more than one parameter group is selected in the selection display area 3017, displayed graphs may be switched according to user operations on the graph display area 303.

The action input area 304 is an area for the user of the management apparatus 20 to input an action of the management apparatus 20. For example, the user may select a desired action using radio buttons 3041 from multiple action candidates. The user may then execute the selected action by operating an execution button 3042. In the example shown in FIG. 5, two actions are available, namely, “Search again with range of input candidate value” and “Modify process to reflect optimum condition”. Each action will be explained later. The number of actions arranged here is not limited to two.

The correction button 305 is a button for the user to select at the time of updating the prediction formula. Upon selection of the correction button 305, the prediction formula is recalculated using the latest information on evaluation values and parameters at that time point.

The description will refer back to FIG. 4. In step S3, the processor 201 determines whether or not an input is given through the top screen 300. For example, if, with the top screen 300, a candidate value is input into the candidate value display area 3013, or any parameter or parameters in the selection display area 3017 are selected, or an input is made to the action input area 304, it is determined that an input has been performed. If it is determined in step S3 that an input has been given through the top screen 300, the processing transitions to step S4. If it is determined in step S3 that no input has been given through the top screen 300, the processing transitions to step S5.

In step S4, the processor 201 holds the input content. The processor 201 then updates the display of the top screen 300 based on the input content. The processing then returns to step S3.

In step S5, the processor 201 determines whether or not to display a graph. For example, if the graph display button 302 is selected in the state where a parameter or parameters in the selection display area 3017 have been selected, it is determined that a graph will be displayed. If it is determined in step S5 that a graph will be displayed, the processing transitions to step S6. If it is determined in step S5 that a graph will not be displayed, the processing transitions to step S7.

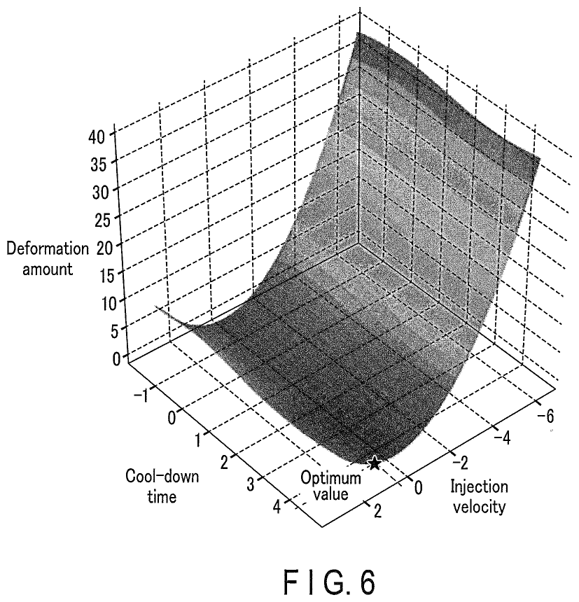

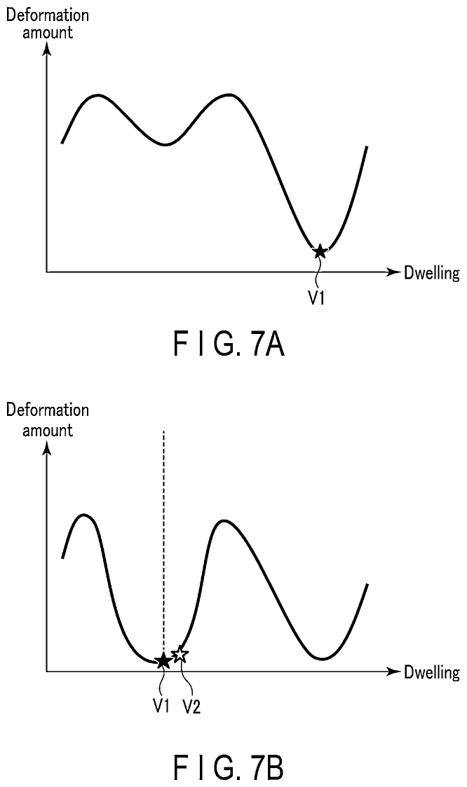

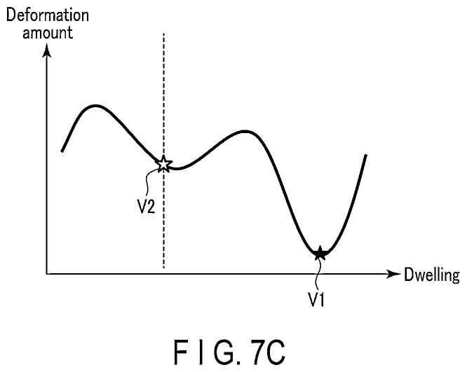

In step S6, the processor 201 display a graph according to the selected parameter or parameters. The processing then returns to step S3. For example, in a case where a group of “Resin temperature” and “Dwelling” has been selected as parameters, the processor 201 displays a graph as shown in FIG. 3 that includes a response surface representing a relationship of a deformation amount with a resin temperature and dwelling. Also, in a case where a group of “Injection velocity” and “Cool-down time” has been selected as parameters, the processor 201 displays a graph as shown in FIG. 6 that is a response surface representing a relationship of a deformation amount with an injection velocity and a cool-down time. In a case where only “Dwelling” has been selected as a parameter, the processor 201 displays a graph as shown in FIG. 7A that is a response curve representing a relationship of a deformation amount with dwelling. The graph shown in FIG. 7A conforms to a two-dimensional plane version of the graph shown in FIG. 3, where the resin temperature is its optimum value. An optimum value V1 of the dwelling on the graph shown in FIG. 7A matches the optimum value of the dwelling on the graph shown in FIG. 3.

In step S7, the processor 201 determines whether or not to search for the prediction formula again. For example, if the execution button 3042 is selected in the state where the action “Search again with range of input candidate value” has been selected using the radio button 3041, it is determined that another search for the prediction formula and optimum values will be performed. If it is determined in step S7 that another search for the prediction formula and optimum values will be performed, the processing transitions to step S8. If it is determined in step S7 that another search for the prediction formula and optimum values will not be performed, the processing transitions to step S11.

In step S8, the processor 201 conducts molding for a given range covering the candidate value, generates an evaluation value and a parameter group for this range, and adds them to the past evaluation values and the past values of parameter groups. Then, in step S9, the processor 201 recalculates the prediction formula and the optimum values. Here, if a candidate value differing from the optimum value has been input by the user of the management apparatus 20, the processor 201 recalculates the prediction formula by prioritizing the range covering the candidate value for the corresponding parameter.

In step S10, the processor 201 updates the display of the top screen 300 based on the result of the recalculation. The processing then returns to step S3. As a concrete processing in step S10, the processor 201 updates the values of the respective parameters in the optimum value display area 3014. If the graph display area 303 shows a graph, the processor 201 also updates the graph representation. FIG. 7B is a diagram showing an example of a displayed graph that has been updated by the recalculation of the prediction formula using a candidate value for dwelling input during the display of the graph shown in FIG. 7A. In FIG. 7B, a symbol V2 refers to the candidate value input by the user of the management apparatus 20, and as in this example, there are instances where the optimum value is derived near the candidate value V2. FIG. 7C is a diagram showing another example of a displayed graph that has been updated by the recalculation of the prediction formula using a candidate value for dwelling input during the display of the graph shown in FIG. 7A. Unlike the case shown in FIG. 7B, there are instances where the optimum value is not derived near the candidate value. With the results as shown in FIGS. 7B and 7C, etc., the user checks the response surfaces, and whether to reflect V1 on the conditions for volume production or adopt V2 is determined in consideration of the know-how of the user. Further explanation of the reflection on the conditions for volume production will be given later in relation to step S15. In the manner as described above, the know-how of the user can be reflected on the calculation of the prediction formula.

In step S11, the processor 201 determines whether or not to correct the prediction formula. For example, in response to the selection of the correction button 305, correction to the prediction formula is determined. If it is determined in step S11 that the prediction formula will be corrected, the processing transitions to step S12. If it is determined in step S11 that the prediction formula will not be corrected, the processing transitions to step S15.

In step S12, the processor 201 adds the evaluation value and the values of the parameter group at the manufacturing to the past evaluation values and the past values of parameter groups. In step S13, the processor 201 carries out recalculation for the correction of the prediction formula. The processor 201, in step S13, recalculates the prediction formula based on the latest evaluation value and the latest values of the parameter group at that time point. This allows the prediction formula to reflect the latest manufacturing result. Accordingly, improvement in accuracy of the generated prediction formula can be expected.

In step S14, the processor 201 updates the display of the top screen 300 based on the result of the correction. The processing then returns to step S3. As a concrete processing in step S14, the processor 201 updates the values of the respective parameters in the optimum value display area 3014. If the graph display area 303 shows a graph, the processor 201 also updates the graph representation.

In step S15, the processor 201 determines whether or not to cause the injection molding machine 10 to reflect the parameters. For example, if the execution button 3042 is selected in the state where the action “Modify the process to reflect the optimum condition” has been selected using the radio button 3041, it is determined that the parameters will be reflected on the injection molding machine 10. If it is determined in step S15 that the parameters will be reflected on the injection molding machine 10, the processing transitions to step S16. If it is determined in step S15 that the parameters will not be reflected on the injection molding machine 10, the processing returns to step S3.

In step S16, the processor 201 transmits the current parameters to the injection molding machine 10 using the communication device 205. The processing then returns to step S3. The parameters for the injection molding machine 10 are thus updated.

According to the embodiment as described above, a prediction formula representing a relationship between a parameter group set for the injection molding machine and an evaluation value indicating the quality of a part to be produced using the parameter group is calculated based on the information on evaluation values and parameters stored in the storage section. This enables the prediction of optimum parameters even without information on clear relationships between an evaluation value and parameters stored. Also, with the configuration of displaying a graph corresponding to the prediction formula in addition to displaying the optimum parameters, a user, etc. of the management apparatus can ascertain the reliability of the prediction results.

According to the embodiment, the prediction formula is recalculated based on a candidate value input by the user of the management apparatus. This allows the prediction formula to even reflect the know-how of the user of the management apparatus.

According to the embodiment, moreover, the prediction formula is corrected based on the latest information on the evaluation value and parameters. Thus, improvement in accuracy can be expected of the prediction formulas.

### Modifications

Modifications of the embodiments will be described. As mentioned above, a manufacturing apparatus such as an injection molding machine produces parts based on many parameters. According to one embodiment, a prediction formula representing the relationship between an evaluation value or values and a parameter or parameters is calculated from the information on evaluation values and parameters, and optimum values are also obtained therefrom. Meanwhile, operational variations of the manufacturing apparatus may occasionally necessitate readjustment of the prediction formula. The embodiment utilizes the correction button for the sake of such readjustment. It would, however, not always be efficient to recalculate the prediction formula using all parameters for all ranges every time a correction is made. The following modifications will assume techniques that enable the prediction formula calculation to be more efficiently performed.

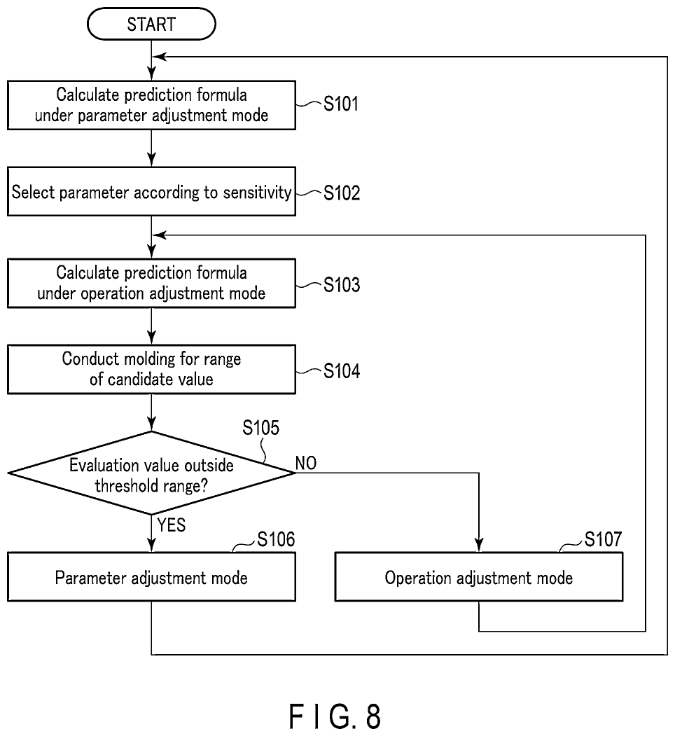

FIG. 8 is a flowchart for explaining a process for prediction formula calculation according to a first modification. The processing steps shown in FIG. 8 are performed, for example, during actual operations of the injection molding machine 10.

In step S101, the processor 201 calculates a prediction formula under a parameter adjustment mode. The parameter adjustment mode is a mode for calculating a prediction formula through an optimum value search technique for multiple variables. In the context of the modifications, multiple variables are three or more variables, and are basically all the parameters. In other words, a prediction formula calculation under the parameter adjustment mode may be the same as the calculation performed in step S1 of FIG. 4.

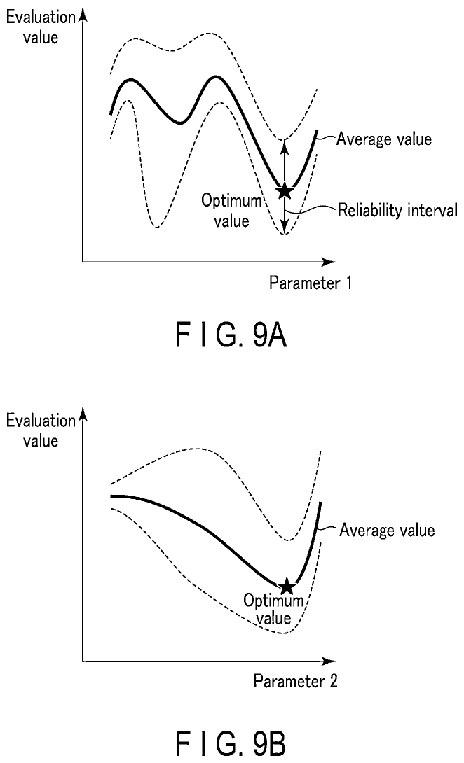

In step S102, the processor 201 selects one of the parameters according to sensitivities. A sensitivity here refers to an index indicating the degree of influence which an individual parameter has on the evaluation value. For analyzing sensitivities of the respective parameters, the processor 201 calculates one-variable response curves each representing the relationship between a given parameter and the evaluation value. FIGS. 9A and 9B show examples of such one-variable response curves. FIG. 9A shows response curves for given parameter 1. FIG. 9B shows response curves for another parameter 2. In each of FIGS. 9A and 9B, the bold curve represents an average response curve. As shown in each of FIGS. 9A and 9B, variations could occur among the response curves. Note that, at the optimum value, the degree of variation is the same irrespective of the difference in parameters, i.e., parameter 1 or 2 as seen from FIGS. 9A and 9B. On the other hand, the variations may have different degrees at values separated from the optimum value, even if these values are in the vicinity of the optimum value. It can be expected that a response curve having a small degree of variation at and near the optimum value has a reproducibility. The optimum value in the case of such a response curve can be said to be highly reliable. Accordingly, the processor 201 selects, from among the parameters, the parameter that gives a response curve showing the lowest degree of variation at and near the optimum value. The variation degree here corresponds to a reliability interval indicated in FIGS. 9A and 9B. Thus, in other words, the processor 201 selects the parameter that shows the narrowest reliability interval at and near the optimum value, from among the parameters. The term “at and near the optimum value” refers to, for example, a range defined as P1′±α, assuming that a group of the optimum value of parameter 1 and the optimum value of parameter 2 is represented by P(P1′,P2′) and that α is a constant. Note that, in instances where there are two or more parameters each giving a response curve of a comparative variation degree at and near the optimum value, the processor 201 selects the parameter that shows the greatest inclination around the optimum value, i.e., the parameter that entails the largest amount of change in the evaluation value, from among these parameters.

In step S103, the processor 201 calculates a prediction formula under an operation adjustment mode. The operation adjustment mode is a mode for calculating, using only the parameter selected in step S102 as a variable, a prediction formula which is different from the prediction formula calculated under the parameter adjustment mode. The prediction formula calculation under the operation adjustment mode may also be performed in step S8 of FIG. 4.

In step S104, the processor 201 conducts molding for a given range of a candidate value of the optimum value obtained from the prediction formula calculated under the operation adjustment mode, and generates an evaluation value and a parameter group. Then, in step S105, the processor 201 determines whether or not the evaluation value falls outside a threshold range. The threshold range is determined based on the prediction formula adjusted using the evaluation values and parameter groups acquired under the parameter adjustment mode. More specifically, and for example, the upper limit value of the threshold range conforms to the allowable upper limit of the reliability interval determined with respect to the average prediction formula, and the lower limit value of the threshold range conforms to the allowable lower limit of the reliability interval determined with respect to the average prediction formula. If it is determined in step S105 that the evaluation value falls outside the threshold range, the processing transitions to step S106. If it is determined in step S105 that the evaluation value is within the threshold range, the processing transitions to step S107.

In step S106, the processor 201 sets the mode for prediction formula calculation to the parameter adjustment mode. The processing then returns to step S101.

In step S107, the processor 201 sets the mode for prediction formula calculation to the operation adjustment mode. The processing then returns to step S103.

According to the first modification described above, only the parameter that gives the lowest degree of prediction formula variation at and near the optimum value is used as a variable to carry out the subsequent prediction formula calculation. Thus, improvement in efficiency can be expected of the prediction formula calculations.

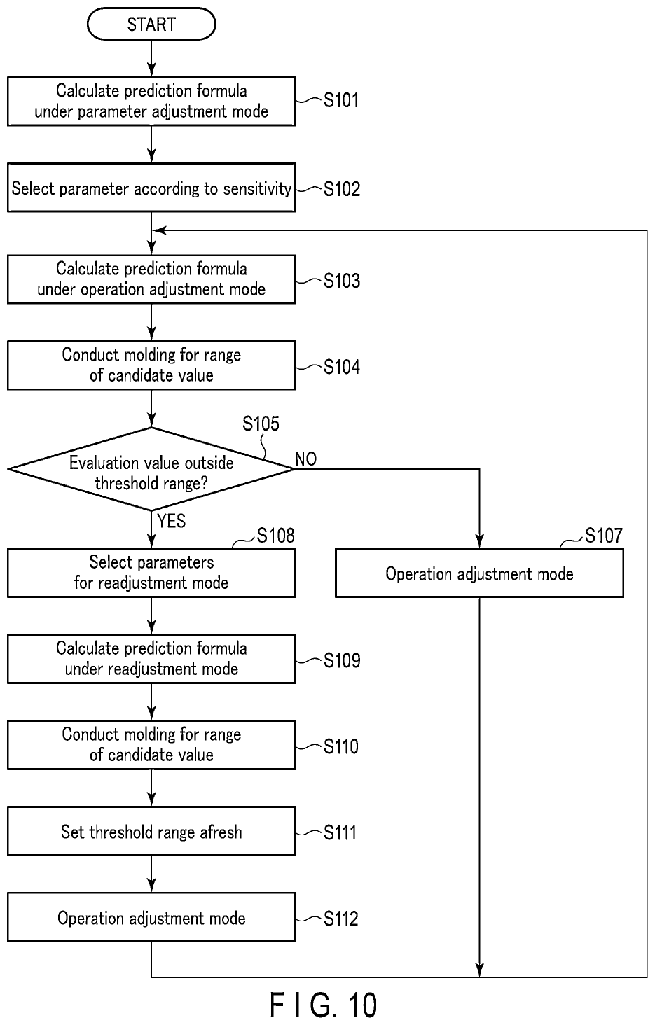

FIG. 10 is a flowchart for explaining a process for prediction formula calculation according to a second modification. FIG. 10 differs from FIG. 8 in that the processing performed in response to the determination in step S105 that the evaluation value falls outside the threshold range is changed from step S106 to steps S108 to S112. The description will concentrate on the differences from FIG. 8.

In step S108, the processor 201 selects parameters for a readjustment mode according to sensitivities. The readjustment mode is a mode for calculating a prediction formula through optimum value search technique for the number of variables between the parameter adjustment mode and the operation adjustment mode. In one example, the number of variables adopted under the readjustment mode is smaller than the number of parameters adopted under the parameter adjustment mode and larger than that adopted under the operation adjustment mode, and it may be, for example, two. Parameters here may be selected in the same manner as the parameter used in the operation adjustment mode. That is, the processor 201 selects two parameters that each give a response curve showing the lowest degree of variation at and near the optimum value.

In step S109, the processor 201 calculates a prediction formula under the readjustment mode. That is, the processor 201 calculates, using only the parameters selected in step S108 as variables, the prediction formula. The prediction formula calculation under the readjustment mode may also be performed in step S13 of FIG. 4.

In step S110, the processor 201 conducts molding for a given range of a candidate value of the optimum value obtained from the prediction formula calculated under the readjustment mode, and generates an evaluation value and a parameter group. Then, in step S111, the processor 201 sets the threshold range afresh. The threshold range here may be set based on the prediction formula adjusted using the evaluation values and parameter groups acquired under the readjustment mode. More specifically, and for example, the upper limit value of the threshold range conforms to the allowable upper limit of the reliability interval determined with respect to the average prediction formula, and the lower limit value of the threshold range conforms to the allowable lower limit of the reliability interval determined with respect to the average prediction formula. After setting the threshold range afresh, the processing transitions to step S112.

In step S112, the processor 201 sets the mode for prediction formula calculation to the operation adjustment mode. The processing then returns to step S103.

According to the second modification described above, if an evaluation value resulting from the case of calculating a prediction formula using, as a variable, only the parameter that gives the lowest degree of prediction formula variation at and near the optimum value falls outside the threshold range, the threshold range is set afresh using more parameters. This would realize reduced errors in the prediction formulas and a higher efficiency as compared to the configuration of returning the calculation mode back to the parameter adjustment mode.

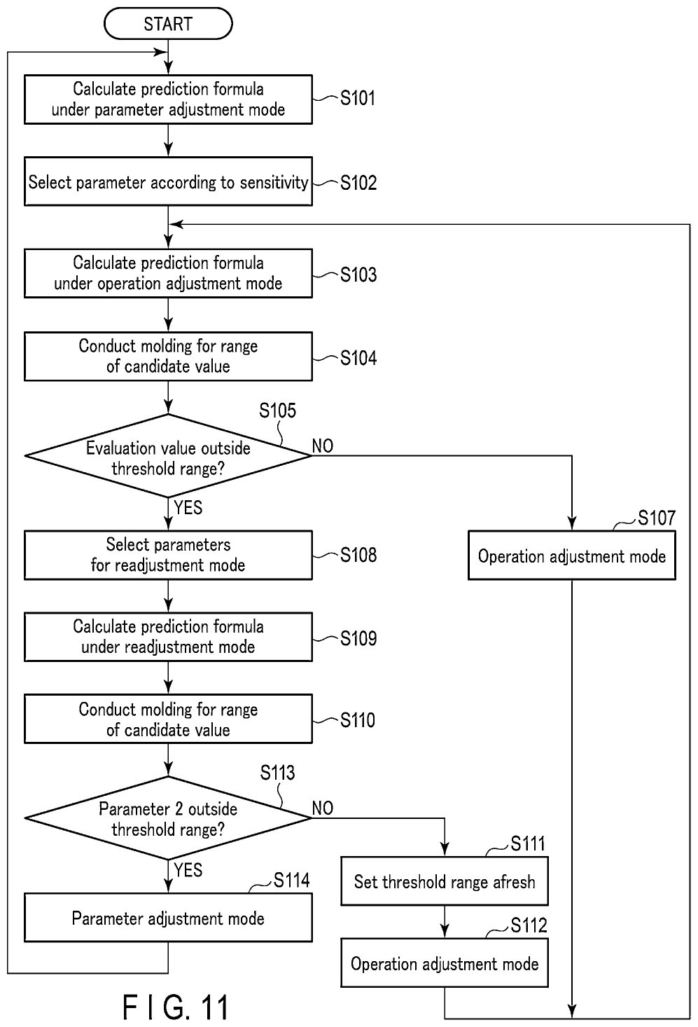

FIG. 11 is a flowchart for explaining a process for prediction formula calculation according to a third modification. FIG. 11 differs from FIG. 10 in that the processing steps S113 and S114 are added after step S110. The description will concentrate on the differences from FIG. 10.

In step S113, the processor 201 determines whether or not parameter 2 falls outside a threshold range. Parameter 2 refers to the other one of the parameters in the case where these parameters have been selected for adjusting the prediction formula using the evaluation values and parameter groups acquired under the readjustment mode, and where one of the parameters, i.e., parameter 1, is the optimum value. The threshold range here is set based on the prediction formula adjusted using the evaluation values and parameter groups acquired under the readjustment mode. If it is determined in step S113 that parameter 2 is within the threshold range, the processing transitions to step S111. In this processing flow, the threshold range is set afresh in the same manner as indicated in FIG. 10. If it is determined in step S113 that parameter 2 falls outside the threshold range, the processing transitions to step S114.

In step S114, the processor 201 sets the mode for prediction formula calculation to the parameter adjustment mode. The processing then returns to step S101.

According to the third modification described above, if parameter 2 is found outside the threshold range after the readjustment mode, the calculation mode is returned back to the parameter adjustment mode. This can further reduce the possibility of error occurrence in the prediction formulas from that in the second modification.

The foregoing embodiments and modifications have assumed the manufacturing apparatus to be an injection molding machine. Note that the disclosed techniques for the embodiments and the modifications are also adoptable in various manufacturing apparatuses other than an injection molding machine, on condition that suitable evaluation values and parameters are selected. For example, for a chemical vapor deposition (CVD) apparatus, the evaluation value or values to be selected may be a film thickness, a film thickness uniformity, a film composition, a film composition uniformity, and/or the like, and the parameter or parameters to be selected may be a pressure, a gas flow rate, a gas flow ratio, a wafer temperature, a wafer rotating speed, a film forming time, a heating time, and/or the like. For a wet etching apparatus, the evaluation value or values to be selected may be an etching amount, an etching amount uniformity, a material selectivity, and/or the like, and the parameter or parameters to be selected may be a chemical solution concentration, a chemical solution mixing ratio, a wafer temperature, a chemical solution temperature, a wafer rotating speed, a processing time, and/or the like. For a slot die coating apparatus, the evaluation value or values to be selected may be a film thickness, a film thickness uniformity, a coating width, and/or the like, and the parameter or parameters to be selected may be a coating speed, a gap absolute amount, a gap amount (a lateral adjustment), a coating liquid supply amount, and/or the like. For a hot air drying apparatus, the evaluation value or values to be selected may be a residual water content, and/or the like, and the parameter or parameters to be selected may be a flow rate, a temperature, a pressure, a processing time, a temperature rise, a cool-down time, and/or the like. For a vacuum heat firing furnace, the evaluation value or values to be selected may be a density, a density uniformity, a crystallinity, and/or the like, and the parameter or parameters to be selected may be a vacuum degree, a temperature, a processing time, a heating and cool-down time, and/or the like.

While certain embodiments have been described, they have been presented by way of example only, and are not intended to limit the scope of the inventions. Indeed, the novel embodiments described herein may be embodied in a variety of other forms. Furthermore, various omissions, substitutions, and changes in the form of the embodiments may be made without departing from the spirit of the inventions. The accompanying claims and their equivalents are intended to cover such forms or modifications as would fall within the scope and spirit of the inventions.

What is claimed is:

1. A management apparatus comprising
a processor comprising hardware and configured to
calculate, based on information on two or more parameters for production of a part and an evaluation value for a quality of the part produced, a prediction formula representing a relationship between the quality and the parameters,
calculate, based on the prediction formula, an optimum value for the parameters, and
cause a display to display a graph indicative of a relationship between the prediction formula and the optimum value.

2. The management apparatus according to claim 1, wherein the processor is configured to recalculate the prediction formula based on latest information on the parameters and the evaluation value.

3. The management apparatus according to claim 1, wherein the processor is configured to recalculate the prediction formula based on a candidate value input by the user for the optimum value.

4. The management apparatus according to claim 1, wherein the parameters comprise three or more parameters, and
the processor is configured to
select, from among the three or more parameters, a parameter having a larger influence on the evaluation value, in the prediction formula calculated using the three or more parameters, and
adjust the prediction formula using the selected parameter.

5. The management apparatus according to claim 4, wherein the processor is configured to adjust afresh the prediction formula using the three or more parameters if an evaluation value in the adjusted prediction formula falls outside a threshold range.

6. The management apparatus according to claim 4, wherein the processor is configured to, if an evaluation value in the adjusted prediction formula falls outside a threshold range,
select afresh, from among the three or more parameters, parameters which are fewer in number than the three or more parameters and greater in number than the selected parameter,
adjust afresh the prediction formula using the parameters selected afresh, which are fewer in number than the three or more parameters and greater in number than the selected parameter,
set afresh the threshold range based on the prediction formula adjusted afresh, and
further adjust the prediction formula using the threshold range set afresh and the parameters selected afresh.

7. The management apparatus according to claim 4, wherein the processor is configured to,
if an evaluation value in the adjusted prediction formula falls outside a threshold range, adjust afresh the prediction formula using parameters which are fewer in number than the three or more parameters and greater in number than the selected parameter, and
if the prediction formula adjusted afresh includes a parameter that falls outside a threshold range, further adjust the prediction formula using the three or more parameters.

8. A management method comprising:
calculating, based on information on two or more parameters for production of a part and an evaluation value for a quality of the part produced, a prediction formula representing a relationship between the quality and the parameters;
calculating, based on the prediction formula, an optimum value for the parameters, and
causing a display to display a graph indicative of a relationship between the prediction formula and the optimum value.

9. A non-transitory computer-readable storage medium storing a management program for causing a processor to:
calculate, based on information on two or more parameters for production of a part and an evaluation value for a quality of the part produced, a prediction formula representing a relationship between the quality and the parameters;
calculate, based on the prediction formula, an optimum value for the parameters, and
cause a display to display a graph indicative of a relationship between the prediction formula and the optimum value.
